(19) United States
(12) Patent Application Publication
(10) Pub. No.: US 2019/0207328 A1
(43) Pub. Date: Jul. 4, 2019

(54) Mechanical Connecting Element, Electrical Contact Device And Electrical Connector

(71) Applicant: TE Connectivity Germany GmbH, Bensheim (DE)

(72) Inventors: Volker Seipel, Bensheim (DE); Harald Kraenzlein, Schopfloch (DE); Uwe Bluemmel, Hemsbach (DE); Christian Gregor, Zwingenberg (DE)

(73) Assignee: TE Connectivity Germany GmbH, Bensheim (DE)

(21) Appl. No.: 16/235,275

(22) Filed: Dec. 28, 2018

(30) Foreign Application Priority Data
Dec. 28, 2017 (DE) 102017131371.0

(51) Int. Cl. H01R 4/02

(52) U.S. Cl. CPC H01R 4/023; H01R 4/029

(57) ABSTRACT

A connecting element comprises a first connecting region receiving a first connecting section and a second connecting region arranged above the first connecting region and receiving a second connecting section. An adhesively bonded connection between the first connecting section and the second connecting section is retained within the first connecting region and the second connecting region.

### CROSS-REFERENCE TO RELATED APPLICATION

This application claims the benefit of the filing date under 35 U.S.C. § 119(a)-(d) of German Patent Application No. 102017131371.0, filed on Dec. 28, 2017.

### FIELD OF THE INVENTION

The present invention relates to a connecting element and, more particularly, to a connecting element for securing an adhesively bonded connection.

### BACKGROUND

Electrical connectors transmit electrical currents, voltages, signals and/or data using a large spectrum of currents, voltages, frequencies and/or data rates. In vehicle applications, for example, connectors must ensure the transmission of electrical power, signals and/or data in warm, possibly hot, unclean, damp and/or chemically aggressive environments permanently, repeatedly and/or after a comparatively long period of inactivity. The connector can be fitted on an electrical cable, a wire, a cable harness, or in an electrical device such as a housing, a pressed frame, or a printed circuit board. A large number of different and specially configured connectors are used across a large spectrum of applications.

U.S. Pat. Nos. 5,948,175 and 5,961,737 each disclose, for a solar cell arrangement, mechanical clamping elements for electrical wires. The wire is fastened on an electrical terminal contact with the clamping element. The clamping element is welded to the terminal contact at at least one location and the wire is soldered to the clamping element and possibly to the terminal contact. The clamping element has a u-shaped or o-shaped cross-section through which a stripped longitudinal end section of the wire extends.

### SUMMARY

A connecting element comprises a first connecting region receiving a first connecting section and a second connecting region arranged above the first connecting region and receiving a second connecting section. An adhesively bonded connection between the first connecting section and the second connecting section is retained within the first connecting region and the second connecting region.

### BRIEF DESCRIPTION OF THE DRAWINGS

The invention will now be described by way of example with reference to the accompanying FIGURE, of which:

FIG. 1 is a perspective view of a connecting element according to an embodiment with a contact device and a cable capable of being connected within the connecting element.

### DETAILED DESCRIPTION OF THE EMBODIMENT(S)

Exemplary embodiments of the present disclosure will be described hereinafter in detail with reference to the attached drawings, wherein like reference numerals refer to like elements. The present disclosure may, however, be embodied in many different forms and should not be construed as being limited to the embodiment set forth herein; rather, these embodiments are provided so that the present disclosure will convey the concept of the disclosure to those skilled in the art.

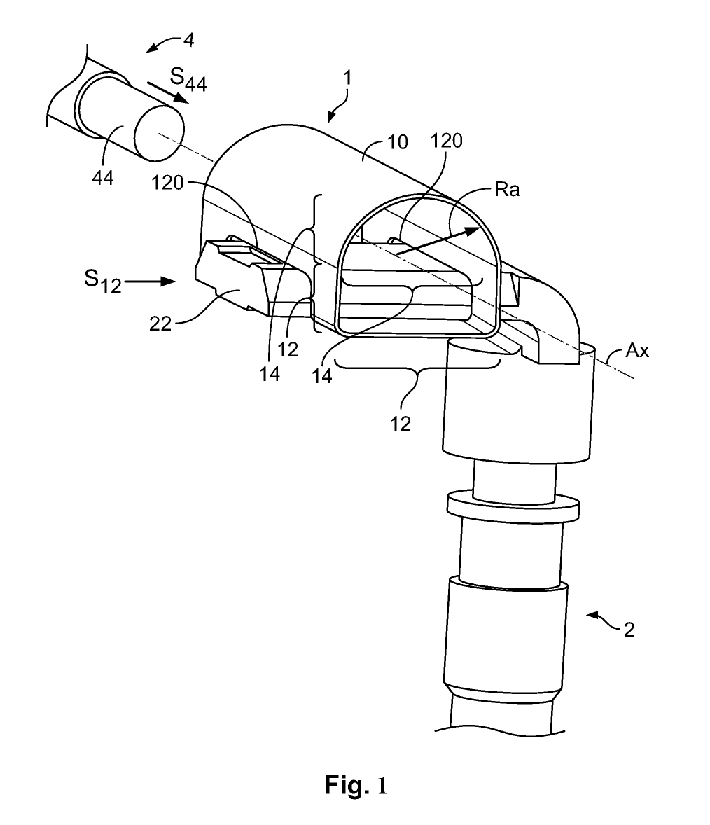

An electrical contact device 2 according to an embodiment is shown in FIG. 1. The electrical contact device 2 has a contact apparatus (shown broken away) and an electrical or electromechanical connecting section 22. In the shown embodiment, the contact device 2 is a pin contact device 2. In other embodiments, the contact device 2 may be a socket contact device, a tab contact device, or other types of contact devices known to those with ordinary skill in the art. The connecting section 22 extends at an approximately 90° angle away from a remainder of the pin contact device 2. In other embodiments, it is of course possible to form other angles here or to form the pin contact device 2 as a straight (180° angle) pin contact device 2.

In the embodiment shown in FIG. 1, the connecting section 22 has a cross-section which has the form of a substantially equal-sided trapezium. In other embodiments, the connecting section 22 may have other cross-sections which allow the connecting section 22 to have a coding with the connecting element 1 as described in greater detail below. Multiply symmetrical cross-sections, such as a rectangular cross-section, can of course likewise be used. The cross-section of the connecting section 22 has a coding form that is formed in a manner complementary to a coding form of the connecting element 1 at least in sections.

The connecting section 22 is adapted to form an adhesively bonded connection, such as by bonding, soldering, or welding, to another connecting section 44. The weld can be a resistance weld or an ultrasonic weld. The connecting section 44 is formed as a connecting section 44 of an electrical cable 4, as shown in the embodiment of FIG. 1, a cable harness 4, or a braid 4. In other embodiments, the connecting section 44 may be the connecting section of another type of electrical component. The connecting section 22 has a level and planar bonding side in an embodiment. In another embodiment, a formation of the bonding side complementary to the connecting section 44 at least in sections can be used. The connecting section 22 of the contact device 2 may be referred to as a first connecting section 22 and the connecting section 44 of the cable 4 may be referred to as a second connecting section 44. As shown in FIG. 1, a longitudinal extent of the connecting section 22 constitutes a first plugging direction S12 of the connecting element 1 on the connecting section 22.

The connecting section 44 of the cable 4 is fixed on a top of the connecting section 22 of the contact device 2, at the bonding side of the connecting section 22, by the adhesive bond. The adhesive bond lies between the connecting sections 22, 44 and within the connecting element 1. In an embodiment, the adhesive bond is established only when the two connecting sections 22, 44 are located within the connecting element 1, for which purpose the connecting element 1 has a corresponding suitability in material or dimension. In other embodiments, it is possible to provide the connecting element 1 around the adhesively bonded connecting sections 22, 44 only after the adhesive bond has been established. In all embodiments, a mechanical connection between the connecting sections 22, 44 may be used instead of the adhesive bond.

The connecting element 1, in the embodiment shown in FIG. 1, has the form of a tube or a cylinder with a u-shaped, closed base area and opposite open ends. Free ends of the two limbs of the u-shape are closed by a substantially straight connecting portion. In other embodiments, base shapes such as ellipses, circles, rectangles, squares, polygons, or composed cross-sections may be used and may be matched to a form of the connecting section 22. Further, instead of such a tube or such a cylinder as shown in FIG. 1, the connecting element 1 may alternatively be in the form of a basket, a cage, or a sleeve. The connecting element 1 may be integrally formed in a single piece, and in an embodiment, is integrally formed in a single piece with the connecting section 22 of the contact device 2.

The connecting element 1 retains the adhesively bonded connection and, in the embodiment shown in FIG. 1, is formed as a double socket connecting element 1. The connecting element 1 includes an outer structure 10 or an outer casing 10, through which passageways 120 extend in a mechanical or electromechanical first connecting region 12. The first connecting region 12 extends in a radial direction Ra into or through the outer structure 10. Spaced apart from the first connecting region 12, the outer structure 10 or outer casing 10 forms a mechanical or electromechanical second connecting region 14. Apart from the two open ends and the two passageways 120, the connecting element 1 can be formed in a closed manner in the region of the outer structure 10 or the outer casing 10. The connecting element 1 limits an adhesively bonded space between the connecting sections 22, 44. In an embodiment, the adhesive bond between the connecting sections 22, 44 can be formed through the outer structure 10 of the connecting element 1.

The first connecting region 12 is a region of the connecting element 1 connecting with the connection section 22 of the contact device 2, as shown in FIG. 1. The second connecting region 14 is a region of the connecting element 1 connecting with the connecting section 44 of the cable 4. Both connecting regions 12, 14 are plugging connecting regions; the first connecting region 12 receives the connecting section 22 of the contact device 2 by plug-in or insertion and the second connecting region 14 receives the connecting section 44 of the cable 4 by plug-in or insertion. The connecting element 1 is inserted onto the connecting section 22 of the contact device 2 in the plugging direction S12 and the connecting section 22 extends through the passageways 120 and within the first connecting region 12. The passageways 120 have a shape coded to be complementary to a shape of the connecting section 22. A longitudinal extent Ax of the second connecting region 14 is a second plugging direction S44 of the connecting section 44 of the cable 4 inserted in the connecting element 1. The second connecting region 14 is arranged above the first connecting region 12. In the shown embodiment, the first connecting region 12 and the second connecting region 14 are arranged in two parallel planes spaced apart from one another.

In an end mounting position of the cable 4 with the contact device 2, in the embodiment of the FIG. 1, the connecting element 1 is provided at an electromechanical adhesively bonded connection of the cable 4 to the contact device 2. In this case, the cable 4 or the cable-connecting section 44 thereof extends in the longitudinal extent Ax and is disposed in the connecting element 1, the longitudinal extent Ax of which is parallel to the extent of the cable 4. At an angle, in particular an approximately 90° angle thereto, the connecting element 1 is plugged onto the contact device 2 or the connecting section 22 thereof, a projection of the longitudinal extent Ax of the connecting element 1 and a longitudinal direction of the connecting section 22 constituting a plane. As shown in FIG. 1, the contact device 2 extends out from this plane at an angle, in particular an angle of approximately 90°.

As shown in FIG. 1, the connecting regions 12, 14 are disposed at an angle of approximately 90° to each other in the connecting element 1. In other embodiments, any desired angle, in particular a 0° angle or 180° angle with both connecting regions 12, 14 extending in an axial direction Ax are possible in addition or as an alternative.

In a method of producing an adhesively bonded connection, the connecting element 1 is assembled with the connecting section 22 of the contact device 2 or the connecting element 1 is already provided or integrally formed with the connecting section 22 of the contact device 2. Thereafter, the connecting section 44 of the cable 4 is placed in the connecting element 1 on the connecting section 22 of the contact device 2. Thereafter, the adhesive bonding process can be carried out between the connecting sections 22, 44.

When the adhesively bonded connection is formed between the connecting sections 22, 44 and surrounded by the connecting element 1, a sudden release of the connection between the contact device 2 and the cable 4 is prevented. The connecting element 1 is a redundant mechanical retention or fixing of the adhesive bond. The connecting element 1 can be constructed simply and is cost-effective in comparison with a cost-intensive crimp connection which, further, requires a specific, comparatively large material thickness. The connecting element 1 saves more space than a crimp connection analogous thereto; a comparatively thin connecting element 1 can be used in comparison with the wall thicknesses of the connecting sections 22, 44.

In an embodiment, the contact device 2, the cable 4, and the connecting element 1 are parts of a connector. In an embodiment, the connector is a charging plug and the contact device 2 is a pin or socket contact device 2. The connecting element 1 described herein can be used in other connectors or in cable harnesses in a variety of applications, such as electronics, electrical engineering, power engineering, or the computer sector.

What is claimed is:

1. A connecting element, comprising:
a first connecting region receiving a first connecting section; and
a second connecting region arranged above the first connecting region and receiving a second connecting section, an adhesively bonded connection between the first connecting section and the second connecting section is retained within the first connecting region and the second connecting region.

2. The connecting element of claim 1, wherein the adhesively bonded connection is a welded connection.

3. The connecting element of claim 1, wherein the first connecting section is inserted into the first connecting region in a first plugging direction perpendicular to a second plugging direction in which the second connecting section is inserted into the second connecting region.

4. The connecting element of claim 1, wherein at least one of the first connecting section and the second connecting section is part of an element separate from the connecting element.

5. The connecting element of claim 4, wherein the connecting element is integrally formed with the first connecting section.

6. The connecting element of claim 4, wherein the first connecting section is part of an electrical contact device.

7. The connecting element of claim 6, wherein the second connecting section is part of an electrical cable.

8. The connecting element of claim 1, wherein the connecting element has a basket, cage, sleeve, or tube shaped form.

9. The connecting element of claim 8, wherein the first connecting region is arranged in a first plane and the second connecting region is arranged in a second plane spaced apart from the first plane.

10. The connecting element of claim 1, further comprising an outer structure defining the first connecting region and the second connecting region.

11. The connecting element of claim 10, wherein the first connecting region extends along a radial direction into the outer structure and the second connecting region extends through the outer structure along a longitudinal direction of the outer structure.

12. The connecting element of claim 10, wherein a pair of passageways extend through the outer structure in the first connecting region.

13. The connecting element of claim 12, wherein the passageways have a shape coded to be complementary to a shape of the first connecting section and the first connecting region extends through the passageways.

14. The connecting element of claim 10, wherein the outer structure is u-shaped and is closed by a straight connecting portion.

15. The connecting element of claim 10, wherein the adhesively bonded connection is formed through the outer structure.

16. An electrical connector, comprising:
an electrical contact device;
an electrical cable; and
a connecting element connecting a first connecting section of the electrical contact device to a second connecting section of the electrical cable, the connecting element including a first connecting region receiving the first connecting section and a second connecting region arranged above the first connecting region and receiving the second connecting section, an adhesively bonded connection between the first connecting section and the second connecting section is retained within the connecting element.
